(19) United States
(12) Patent Application Publication
(10) Pub. No.: US 2009/0239434 A1
(43) Pub. Date: Sep. 24, 2009

(54) METHOD FOR PRODUCING A FIBER-REINFORCED CARBIDE CERAMIC COMPONENT AND CARBIDE CERAMIC COMPONENT

(75) Inventors: Bodo Benitsch, Buttenwiesen (DE); Bernhard Heidenreich, Asperg (DE); Christian Zuber, Berglen (DE)

Correspondence Address: LERNER GREENBERG STEMER LLP, P O BOX 2480, HOLLYWOOD, FL, 33022-2480, US

(73) Assignees: SGL CARBON AG, Wiesbaden (DE); DEUTSCHES ZENTRUM FUR LUFT- UND RAUMFAHRT E. V., Koln (DE)

(21) Appl. No.: 12/478,914

(22) Filed: Jun. 5, 2009

Related U.S. Application Data
(63) Continuation of application No. PCT/EP2008/051108, filed on Jan. 30, 2008.

(30) Foreign Application Priority Data
Feb. 12, 2007 (DE) 10 2007 007 410.9

(51) Int. Cl. C04B 35/573; C04B 35/80; B32B 5/02

(52) U.S. Cl. 442/179; 427/228; 264/640; 427/180; 264/605; 442/301; 442/246; 428/408

(57) ABSTRACT

A method of producing a fiber-reinforced carbide-ceramic component includes producing a carbonaceous article from at least one unidirectional tape by pyrolysis, infiltrating the carbonaceous article with carbide former, and coating the at least one unidirectional tape with a coating material being volatile in pyrolysis and/or providing the at least one unidirectional tape with a transverse thread system including transverse threads composed of a material being volatile in pyrolysis. A fiber-reinforced carbide ceramic component is also provided.

### CROSS-REFERENCE TO RELATED APPLICATION

This is a continuing application, under 35 U.S.C. § 120, of copending International Application No. PCT/EP2008/051108, filed Jan. 30, 2008, which designated the United States; this application also claims the priority, under 35 U.S.C. § 119, of German Patent Application DE 10 2007 007 410.9, filed Feb. 12, 2007; the prior applications are herewith incorporated by reference in their entirety.

### BACKGROUND OF THE INVENTION

### Field of the Invention

The invention relates to a method of producing a fiber-reinforced carbide-ceramic component in which at least one unidirectional tape is used to produce a carbonaceous article by pyrolysis.

The present invention further relates to a carbide-ceramic component.

German Published, Non-Prosecuted Patent Application DE 41 02 909 A1, corresponding to UK Patent Application GB 2 252 315A, discloses fiber-reinforced ceramic workpieces which are formed of two or more juxtaposed laid ceramic fiber scrims surrounded by a matrix material, the laid fiber scrims having different structures and/or being formed of different materials.

European Patent Application EP 1 547 992 A1 discloses a method of producing a component constructed of a fiber composite material, in which the method includes pyrolyzing a fiber-resin mixture with uncured resin.

Carbide-ceramic components produced by using unidirectional (UD) tapes, in principle have the advantage that they are stiff and resist extension. They can therefore be used for load-bearing structures. Their strength can be high. Due to high stiffness and strength, they can be made thin, allowing lightweight construction.

However, the production of UD-reinforced ceramic components is problematic because the very severe and markedly anisotropic shrinkage in the course of pyrolysis can lead to delamination in the course of carbide-former infiltration.

### SUMMARY OF THE INVENTION

It is accordingly an object of the invention to provide a method of producing a fiber-reinforced carbide-ceramic component and a fiber-reinforced carbide-ceramic component, which overcome the hereinafore-mentioned disadvantages of the heretofore-known methods and products of this general type and in which the component is UD fiber reinforced.

With the foregoing and other objects in view there is provided, in accordance with the invention, a method of producing a fiber-reinforced carbide-ceramic component. The method comprises producing a carbonaceous article from at least one unidirectional tape and a matrix material by pyrolysis and infiltrating the carbonaceous article with carbide former. The at least one unidirectional tape is coated with a coating material being volatile in the pyrolysis and/or the at least one unidirectional tape is provided with a transverse thread system including transverse threads composed of a material being volatile in the pyrolysis.

The pyrolysis disintegrates the coating material. Voids are formed as a result, which ensure that carbide-former infiltration is improved. Passageways can also be formed at the unidirectional tape as a result, through which the carbide former is able to flow in the course of carbide-former infiltration. The coating material facilitates carbide-former infiltration (with liquid silicon, for example).

The coating material may cover the entire surface of the at least one unidirectional tape or a part (the predominant part, for example) of the entire surface area.

Alternatively or additionally to the coating, the at least one unidirectional tape includes a transverse thread system including transverse threads composed of a material volatile in pyrolysis. The transverse threads are not parallel to the fibrous rovings which form the plies of the unidirectional tape. They cut these fibrous rovings geometrically, i.e., they lie at an angle greater than 0° and less than 180° thereto. These transverse threads disintegrate in the course of pyrolysis to form voids and/or passageways for carbide-former infiltration.

Furthermore, the transverse threads prevent uncontrolled cracking during pyrolysis. The transverse threads effectuate shrinkage control within UD plies perpendicularly to the fiber direction. This promotes the formation of the uniform system of cracks. This in turn promotes uniform carbide-former infiltration.

A transverse thread system makes unidirectional tapes able to be handled and they can be cut into transportable plies. A transverse thread system further makes prepregs easier to obtain. Processing by wet lamination, resin infiltration, pressing, autoclaving and the like, for example, is possible with minimal distortion of unidirectional fibers, if any.

It is favorable for the (at least partially) fiber-reinforced carbide-ceramic component to be produced with at least one UD fibrous reinforcing ply. This makes it possible to produce a stiff component which resists extension. The component can be produced with high strength adapted to the later stress which it will experience. It can further be produced to have high damage tolerance. This makes it possible to use it for load-bearing structures, for example, even when it has been made thin.

The coating material is, in particular, a resin material such as epoxy resin for example. Other coating materials such as thermoplastic coating materials are also possible.

It is favorable for the coating material to be substantially residuelessly volatile in pyrolysis.

The at least one unidirectional tape is a system of at least approximately parallel fibrous rovings. The fibrous rovings (fibrous strands or fibrous bundles) are composed of fibrous filaments.

More particularly, the transverse threads are constructed in such a way that they disintegrate substantially residuelessly in pyrolysis.

In order to inhibit uncontrolled cracking during pyrolysis, transverse threads of the transverse thread system are tied together with fibrous rovings of the unidirectional tape and/or fixed to fibrous rovings and/or held to fibrous rovings.

For example, transverse threads are fixed through loops to fibrous rovings of the at least one unidirectional tape. They can also, for example, be woven or stitched together with the fibrous rovings of the at least one unidirectional tape. This makes it possible to prevent uncontrolled cracking during pyrolysis.

It is favorable for the carbonaceous article to be produced through the use of the at least one unidirectional tape and at least one fibrous weave and/or fibrous knit and/or fibrous web. The inclusion of fibrous weaves/fibrous knits/fibrous webs makes it possible to produce a defined structure of microcracks which features a uniform system of cracks in the pyrolysis. As a result, the carbide-ceramic component produced will have damage-tolerant characteristics. The structure of microcracks is made up of translaminar passageways, dense C/C bundles (C/C denotes carbon fibers embedded in a carbon matrix) and capillaries, which are parallel to the unidirectional fibrous plies. The fibrous plies between unidirectional fibrous rovings lead to shrinkage control perpendicularly to the unidirectional orientation. This makes it possible to produce a crack structure featuring a uniform pattern of cracks.

It is favorable for the carbonaceous article to be produced by using a plurality of fibrous reinforcing plies, wherein at least one fibrous reinforcing ply is a unidirectional fibrous reinforcing ply and at least one fibrous reinforcing ply is a fibrous weave ply or fibrous knit ply or fibrous web ply. The UD fibrous reinforcing ply endows the component even in a thin embodiment with high stiffness and strength. The at least one further fibrous reinforcing ply including a “two-dimensional” fibrous structure (the UD fibrous reinforcing ply has a “one-dimensional” fibrous structure) gives a homogeneous microstructure in the production of the component.

For example, the at least one fibrous weave and/or fibrous knit is a 0°/90° body with regard to the orientation of fibrous rovings. This provides a defined way of producing, in the pyrolysis, a microcrack structure which in turn leads to the formation of a homogeneous microstructure in the carbide-ceramic component. Orientations other than 0°/90° are also possible in the body.

More particularly, the carbonaceous article is produced by using an alternating assembly of UD tapes and fibrous weaves or fibrous knits or fibrous webs. Preferably, a unidirectional tape is disposed between adjacent fibrous weaves and/or fibrous knits and/or fibrous webs. A homogeneous microstructure can be achieved as a result.

In one embodiment, a green article is produced by using the at least one unidirectional tape and a matrix material and is subsequently pyrolyzed. The green article is produced by addition polymerization of a resin material, in particular. Pyrolysis of the green article produces a carbonaceous article and particularly a C/C article. Carbide-former infiltration, such as by silicization for example, produces a carbide-ceramic article, such as a C/C—SiC article, for example.

The green article is produced for example in an autoclave and/or by pressing and/or by wet lamination and/or by a resin infiltration process.

In an alternative embodiment, an initial article is produced by using the at least one unidirectional tape and a matrix material and is pyrolyzed in the uncured state of the matrix material. A corresponding method is described in European Patent Application EP 1 547 992 A1. The carbonaceous article is thereby obtainable in a shorter processing time. Moreover, pyrolysis of the matrix material leads, particularly at high rates of heating, to bubble/blister formation in a unidirectional fibrous ply, thereby providing further voids for carbide-former infiltration.

The initial article is produced through the use of prepreg material, for example. The employed UD tapes and fibrous weaves/fibrous knits/fibrous webs are impregnated with matrix material. It is also possible, for example, to produce the initial article by wet lamination.

In particular, the pyrolysis is carried out in one or more cycles and particularly heating cycles and cooling cycles. Fine-tuning the cycles with regard to temperature profile and duration makes it possible to obtain an optimized carbonaceous article.

In particular, the matrix material is a resin, for example a polymeric resin. The pyrolysis can be used to convert the resin into carbon. The polymeric resin is a phenol-based resin, in particular.

Favorably, the at least one unidirectional tape includes carbon fibers. Any fibrous weaves/fibrous knits/fibrous webs used may likewise include carbon fibers. It is then possible, for example, to produce a C/C—SiC component including UD fibrous reinforcement.

The carbide former is silicon, in particular. However, it is also possible to use other carbide-former materials such as tungsten or titanium, for example.

It is favorable for the ceramicization of the carbon to be effected through the use of infiltration of liquid carbide former. This makes it possible to obtain carbide-ceramic components having favorable properties. Ceramicization is effected by following the known liquid silicon infiltration (LSI) process, in particular. The LSI process includes a melt phase infiltration process.

With the objects of the invention in view, there is also provided a carbide-ceramic component produced by the method according to the invention.

With the objects of the invention in view, there is furthermore provided a carbide-ceramic component, comprising at least one unidirectional fibrous reinforcing ply having a microstructure with dense regions of carbon fiber bundles embedded in a carbon matrix (C/C regions) in the at least one unidirectional fibrous reinforcing ply.

As a result, the component has high tensile and compressive strength and also high flexural strength. It can be made thin with high stiffness and resistance to extension.

In accordance with another feature of the invention, the component includes at least one fibrous weave ply and/or fibrous knit ply and/or fibrous web ply as the fibrous reinforcing ply. This makes it possible to obtain the component with a homogeneous microstructure. This in turn makes it possible to obtain damage-tolerant characteristics.

In particular, the component includes alternating unidirectional fibrous reinforcing plies and fibrous weave plies/fibrous knit plies/fibrous web plies. This makes it possible to obtain a homogeneous microstructure.

In particular, the C/C regions are composed of dense bundles of carbon fiber filaments embedded in a matrix of carbon.

Other features which are considered as characteristic for the invention are set forth in the appended claims.

Although the invention is illustrated and described herein as embodied in a method for producing a fiber-reinforced carbide ceramic component and a carbide ceramic component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic illustration of an operative example of a unidirectional tape having a transverse thread system;

FIG. 2 is a scanning electron micrograph of a first sample in 35-times magnification;

FIG. 3 is a scanning electron micrograph of a second sample in 35-times magnification; and

FIG. 4 is a scanning electron micrograph of a third sample in 35-times magnification.

### DETAILED DESCRIPTION OF THE INVENTION

Carbide-ceramic components are typically obtained by using a carbide-former material to ceramicize a carbonaceous article obtained by pyrolysis.

Silicon is one example of a carbide-former material. The component obtained is then a silicon carbide ceramic component based on a nonoxidic ceramic. The component obtained is a C/C—SiC component, for example.

The component may be made of a ceramic matrix composite (CMC). The ceramic matrix embeds fibers such as carbon fibers, for example.

The carbonaceous article is produced by pyrolysis of an initial article. This is produced through the use of fibers and a matrix material such as for example a polymeric resin (plastic): an initial article composed of carbon fiber reinforced plastic (CRP) is pyrolyzed to obtain a carbonaceous (C/C) article. Carbide-former infiltration such as by silicization, for example, produces a carbide-ceramic article such as a C/C—SiC article, for example.

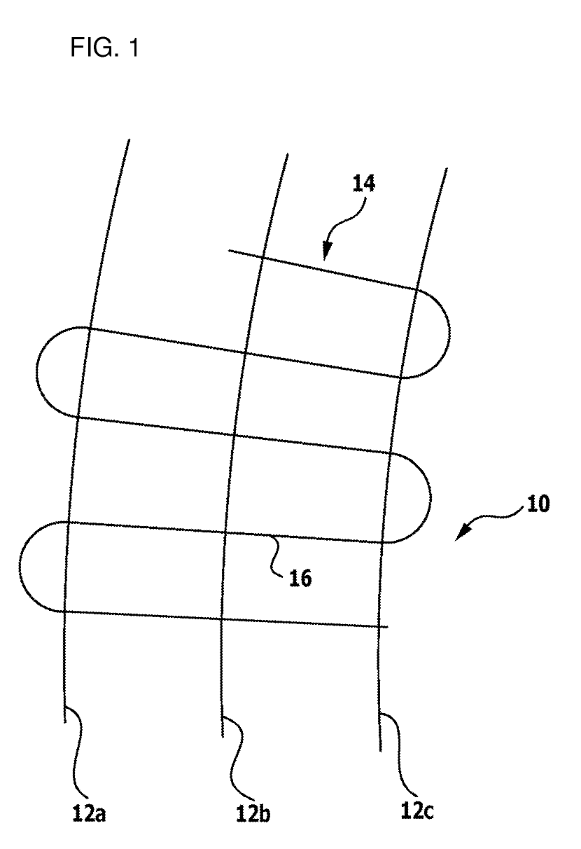

The present invention provides that the component obtained is obtained by using a unidirectional (UD) tape to provide a UD fibrous reinforcement. Referring now to the figures of the drawings in detail and first, particularly, to FIG. 1 thereof, there is seen a unidirectional tape 10 which includes a plurality of at least approximately parallel fibrous rovings 12a, 12b, 12c, etc. The fibrous rovings are each bundles of fibrous filaments. The fibrous rovings need to be in a spaced-apart parallel configuration or else be close together.

These fibers are carbon fibers, for example.

The present invention provides that the unidirectional tape or tapes 10 being used have been wholly or partly coated, on both sides in particular, with a material, in particular a resin, that is volatile at pyrolysis. An epoxy resin is used as a coating, for example. Preferably, the material for the coating is selected in such a way that the coating material is substantially residuelessly volatile in pyrolysis.

The coating can be with a powder, for example.

Alternatively or additionally to the coating with a material that is volatile in pyrolysis, the at least one unidirectional tape 10 is provided with a transverse thread system 14. Transverse threads 16 are fixed to the fibrous rovings 12a, 12b, 12c. The transverse threads 16 are fixed to individual fibrous rovings, for example, by loop formation or by penetration. The transverse threads 16 of the transverse thread system 14 are, for example, stitched or woven to the fibrous rovings.

The transverse threads 16 are made of a material and particularly a plastics material which is likewise volatile at pyrolysis. In particular, the material of the transverse threads 16 is substantially residuelessly volatile in the course of the pyrolysis.

The initial step is to produce an initial article through the use of matrix material and the at least one unidirectional tape.

It is possible in principle that the fiber content in the initial article resides solely in the at least one unidirectional tape 10, or that, in addition, fibrous knits or fibrous weaves or fibrous webs are also used to form “two-dimensional” fibrous reinforcing plies which each include fibrous rovings in different directions. For example, fibrous weaves are additionally used that include fibrous rovings in a 0°/90° orientation. In other words, they include fibrous rovings in a first group which are spaced apart in a substantially parallel configuration, and in a second group which are likewise spaced apart in a substantially parallel configuration, with the fibrous rovings of the first group and the fibrous rovings of the second group being substantially perpendicular to each other. The fibrous rovings of the first group and the fibrous rovings of the second group can be disposed in a plain weave construction, for example. The fibers are carbon fibers, for example. A plurality of fibrous plies can be provided in such a case. An example is an alternating sequence of weave plies and unidirectional tapes 10.

After the initial article has been produced, one embodiment includes producing a CRP green article from the initial article by thermal curing of the matrix material. Curing is effected, for example, by autoclaving, in which case the matrix material is cured in a pressure vessel sealed gas-tight.

The CRP green article is also obtainable, for example, through a resin infiltration process such as resin transfer molding (RTM), through hot pressing or through wet lamination.

The green article thus obtained is then pyrolyzed at high temperatures (particularly above 1,600° C.) for carbonization.

It is also possible in principle for the initial article to be pyrolyzed directly, without prior final curing of the resin material. For example, the materials used may be prepreg materials (UD tapes 10 and/or fibrous weaves/fibrous knits/fibrous webs) which have been impregnated with a curable matrix material (resin material in particular). The initial article is pyrolyzed directly, without production of a green article.

An appropriate process is described in European Patent Application EP 1 547 992 A1, which is expressly incorporated herein by reference. Pyrolysis is effected from the A-state and/or B-state of the resin used as matrix material, and not from the C-state.

In the case of this direct pyrolysis it is contemplated in particular that two or more heating cycles (oven cycles) are carried out. For example, a nine hour heating phase from 20° C. to 900° C. is followed by a seven hour heating phase from 100° C. to 1,650° C., a 0.5 hour phase of maintaining a temperature of 1,650° C., then by a two hour cooling cycle from 1,650° C. to 1,000° C., and a twelve hour cooling cycle from 1,000° C. to 20° C. Direct pyrolysis has the advantage of a reduced processing time.

The result of the pyrolysis with both embodiments is a carbonaceous article which is fiber-reinforced through the use of at least one UD fibrous reinforcing ply and optionally by fibrous weave plies/fibrous knit plies/fibrous web plies. The pyrolysis has “eliminated” the coating on the at least one unidirectional tape 10 by decomposition or removal, and/or decomposed the transverse threads 16 of the transverse thread system 14. Passageways have formed in the process which facilitate liquid infiltration of the carbide former.

The carbonaceous article is subsequently infiltrated with carbide former. For example, a silicon infiltration is carried out as per the familiar LSI process. A carbide-ceramic matrix is formed as a result. The component produced is a carbide-ceramic component which is fiber-reinforced through at least one UD fibrous reinforcing ply.

The method provided by the present invention, involving at least one unidirectional tape 10 with a pyrolysis-volatile coating or/and with a pyrolysis-volatile transverse thread system 14, makes it possible to produce UD-reinforced carbide-ceramic components. One problem with producing fiber-reinforced carbide-ceramic components by using unidirectional tapes 10 is that, due to uncontrolled shrinkage, liquid carbide-former infiltration is not possible or leads to unfavorable properties on the part of the component, particularly to an inhomogeneous microstructure, which render such a component not very suitable for load-bearing structures, for example. Carbide-former infiltration results in delamination, in particular.

The method proposed according to the present invention provides voids and/or passageways for carbide-former infiltration, through each of which these problems are prevented or at least greatly reduced. The method proposed in accordance with the present invention makes it possible to produce UD fiber-reinforced carbide-ceramic components. Production is possible through a melt infiltration process such as the LSI process, for example. Fibers/filaments do not have to be provided with additional fiber protection (such as carbon or BN through CVD or wet-chemical processes).

UD fiber-reinforced carbide-ceramic components are of high stiffness provided the above-described production problems, which are avoided or greatly reduced when proceeding in accordance with the present invention, do not arise. They can be made thin and resist extension. They can be produced with high strength for load-bearing structures in particular. Furthermore, the method proposed according to the present invention makes it possible to keep the processing time short.

An alternating plied assembly involving unidirectional tapes 10 and “two-dimensional” fibrous weaves/fibrous knits/fibrous laid scrims makes it possible to produce a microstructure which leads to damage-tolerant characteristics.

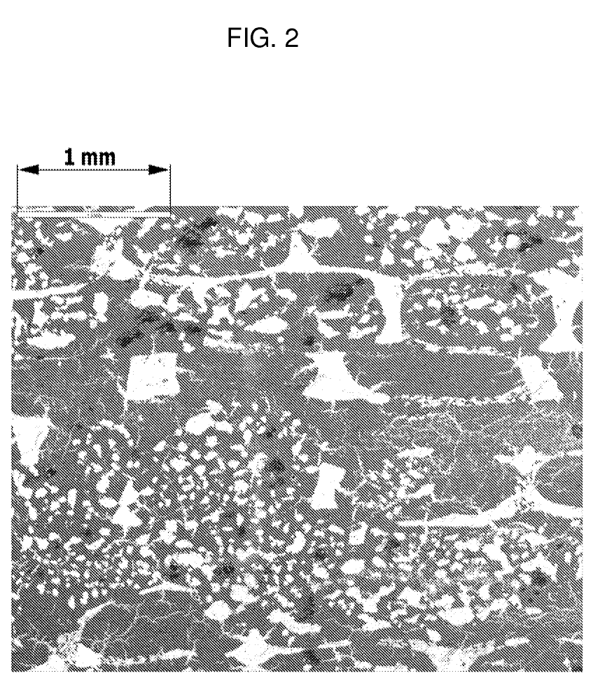

FIG. 2 shows a scanning electron micrograph of a first sample wherein fibrous reinforcement is solely effected through unidirectional tape 10. The component in question was produced by prepreg pyrolysis (that is, by direct pyrolysis of the initial article without prior production of a green article). The carbonaceous article produced by pyrolysis was ceramicized through the LSI process. The light-colored visible parts are ceramic regions. The fiber volume content of the first sample is 43.5%.

The short flexural strength parallel to the fiber direction of the first sample is 250.4 MPa. The microstructure, as can be seen from FIG. 2, is inhomogeneous.

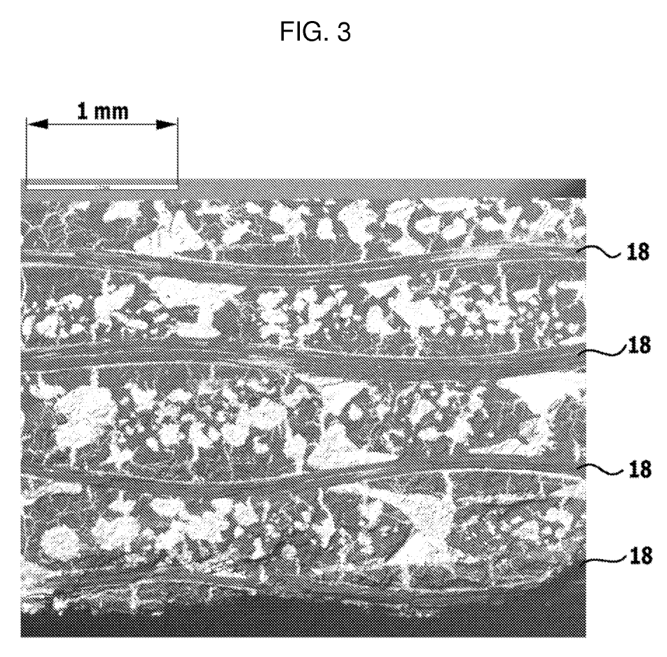

FIG. 3 shows a scanning electron micrograph of a second sample produced by prepreg pyrolysis, which includes alternating unidirectional tape plies and carbonaceous weave plies. The carbonaceous weave plies are indicated in FIG. 3 by reference numeral 18. The unidirectional tape plies lie between the carbonaceous weave plies 18. The light-colored regions are again ceramic regions.

The fiber volume content of the second sample is 44.8% and the short flexural strength is 147.8 MPa.

It can be seen that the microstructure in the second sample is more homogeneous than in the first sample (according to FIG. 2). Incorporating the carbonaceous weave plies leads to a microcrack structure in pyrolysis. This microcrack structure results in a more homogeneous microstructure for the composite, which also leads to more damage-tolerant characteristics for the composite. Short strength is lower, however.

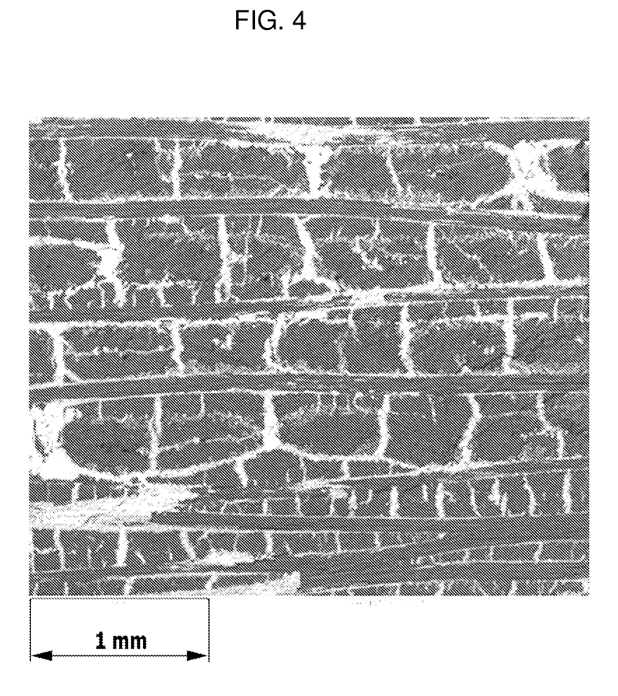

A third sample, shown in FIG. 4 as a scanning electron micrograph, was produced through alternating assembly of weave plies (composed of carbon) and unidirectional tapes 10. The first step was to convert an initial article into a CRP green article by autoclaving to cure the matrix material (phenolic resin). This green article was then pyrolyzed and subsequently infiltrated with molten silicon (through the use of the LSI process) and ceramicized.

It can be seen from FIG. 4 that the third sample has a homogeneous microstructure.

1. A method of producing a fiber-reinforced carbide-ceramic component, the method comprising the following steps:
producing a carbonaceous article from at least one unidirectional tape and a matrix material by pyrolysis;
infiltrating the carbonaceous article with carbide former; and
performing at least one of the following steps:
coating the at least one unidirectional tape with a coating material being volatile in the pyrolysis step, or
providing the at least one unidirectional tape with a transverse thread system including transverse threads composed of a material being volatile in the pyrolysis step.

2. The method according to claim 1, which further comprises carrying out the coating step with a powder.

3. The method according to claim 1, wherein the coating material is a resin material.

4. The method according to claim 1, wherein the coating material is an epoxy resin.

5. The method according to claim 1, wherein the coating material is substantially residuelessly volatile in the pyrolysis step.

6. The method according to claim 1, wherein the at least one unidirectional tape is a fibrous system including at least approximately parallel fibrous rovings.

7. The method according to claim 1, wherein the transverse thread system is constructed such that it disintegrates substantially residuelessly in the pyrolysis step.

8. The method according to claim 1, wherein the transverse threads of the transverse thread system are tied together with fibrous rovings and/or fixed to fibrous rovings and/or held to fibrous rovings.

9. The method according to claim 1, wherein the transverse threads are fixed through loops to fibrous rovings of the at least one unidirectional tape.

10. The method according to claim 1, wherein the transverse threads are stitched together with fibrous rovings of the at least one unidirectional tape.

11. The method according to claim 1, wherein the transverse threads are woven together with fibrous rovings of the at least one unidirectional tape.

12. The method according to claim 1, which further comprises producing the carbonaceous article from the at least one unidirectional tape and at least one fibrous weave and/or fibrous knit and/or fibrous web.

13. The method according to claim 12, which further comprises producing the carbonaceous article by using a plurality of fibrous reinforcing plies, at least one fibrous reinforcing ply being a unidirectional fibrous reinforcing ply and at least one fibrous reinforcing ply being a fibrous weave ply or fibrous knit ply or fibrous web ply.

14. The method according to claim 12, wherein the at least one fibrous weave and/or fibrous knit has a 0°/90° system with regard to an orientation of fibrous rovings.

15. The method according to claim 12, which further comprises producing the carbonaceous article by using an alternating assembly of unidirectional tapes and fibrous weaves or fibrous knits or fibrous webs.

16. The method according to claim 1, which further comprises producing a green article by using the at least one unidirectional tape and a matrix material, and pyrolyzing the green article.

17. The method according to claim 16, which further comprises producing the green article in an autoclave and/or by pressing and/or by wet lamination and/or by winding and/or through resin infiltration.

18. The method according to claim 1, which further comprises producing an initial article by using the at least one unidirectional tape and a matrix material, and pyrolyzing the green article in an uncured state of the matrix material.

19. The method according to claim 17, which further comprises producing the green article from prepreg material.

20. The method according to claim 18, which further comprises producing the initial article from prepreg material.

21. The method according to claim 1, which further comprises carrying out the pyrolysis step in one or more cycles.

22. The method according to claim 16, wherein the matrix material is a resin.

23. The method according to claim 16, wherein the matrix material is a polymeric resin.

24. The method according to claim 1, wherein the at least one unidirectional tape includes carbon fibers.

25. The method according to claim 1, wherein the carbide former is silicon.

26. The method according to claim 1, which further comprises carrying out a ceramicization of the carbonaceous article by infiltration of liquid carbide former.

27. A carbide-ceramic component produced by the method according to claim 1.

28. A carbide-ceramic component, comprising:
at least one unidirectional fibrous reinforcing ply having a microstructure with dense regions of carbon fiber bundles embedded in a carbon matrix (C/C regions) in said at least one unidirectional fibrous reinforcing ply.

29. The carbide-ceramic component according to claim 28, which further comprises at least one fibrous weave ply and/or fibrous knit ply and/or fibrous web ply as said at least one fibrous reinforcing ply.

30. The carbide-ceramic component according to claim 28, which further comprises alternating unidirectional fibrous reinforcing plies and fibrous weave plies or fibrous knit plies or fibrous web plies.
